(19) United States
(12) Patent Application Publication
(10) Pub. No.: US 2012/0125293 A1
(43) Pub. Date: May 24, 2012

(54) INJECTOR HOLE STRUCTURE FOR ENGINE

(75) Inventors: Changyeol Choi, Yongin-si (KR); Seongsoo Lee, Hwaseong-si (KR)

(73) Assignee: Hyundai Motor Company, Seoul (KR)

(21) Appl. No.: 13/160,035

(22) Filed: Jun. 14, 2011

(30) Foreign Application Priority Data
Nov. 23, 2010 (KR) 10-2010-0117148

(51) Int. Cl. F02M 61/14

(52) U.S. Cl. 123/470

(57) ABSTRACT

An injector hole structure for an engine, may include an inlet portion and an outlet portion, a wall narrowing from the inlet portion to the outlet portion, and a tumble generating protrusion protruding from an inner surface of the wall toward a center axis of the wall and having a concentric circular shape with the inlet portion or the outlet portion or a tumble generating groove depressed on an inner surface of the wall away from a center axis of the wall and having a concentric circular shape with the inlet portion or the outlet portion.

### CROSS-REFERENCE TO RELATED APPLICATIONS

The present application claims priority to Korean Patent Application Number 10-2010-0117148 filed Nov. 23, 2010, the entire contents of which application is incorporated herein for all purposes by this reference.

### BACKGROUND OF THE INVENTION

1. Field of the Invention

The present invention relates to an injector hole structure for an engine, and more particularly, to an injector hole structure that is formed in an injector directly injecting fuel into a combustion chamber to ensure a sufficient injection amount and improve mixing efficiency of air and fuel.

2. Description of Related Art

Injectors of not only diesel engines, but the latest styles of engines, such as GDI engines generally directly inject fuel into a combustion chamber.

The injectors that directly inject the fuel into the combustion chamber, as described above, should be able to inject a sufficient amount of fuel for combustion in the engines and sufficiently mix the injected fuel with air within a short time to be advantageous in combustion.

That is, a sufficient amount of fuel corresponding to desired output should be able to be injected through the injector holes of the injectors in order to ensure sufficient output of the engines while the fuel and the air should be mixed well such that the injected fuel is burned as completely as possible in order to improve the fuel efficiency of the engines and reduce toxic substances in the exhaust gas.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an injector hole structure for an engine which can ensure high output of the engine to be advantageous in fuel efficiency and reduce toxic substances in the exhaust gas, by ensuring sufficient mixing efficiency of fuel and air by inducing tumble in the combustion chamber, and injecting a sufficient amount of fuel.

In an aspect of the present invention, the injector hole structure for an engine, may include an inlet portion and an outlet portion, a wall narrowing from the inlet portion to the outlet portion, and a tumble generating protrusion protruding from an inner surface of the wall toward a center axis of the wall and having a concentric circular shape with the inlet portion or the outlet portion.

The inlet portion and the outlet portion may be coaxially arranged wherein the tumble generating protrusion may include a protrusion-starting portion, a protrusion-keeping portion, and a protrusion-ending portion, which may be sequentially connected along the inner surface of the wall in a direction from the inlet portion toward the outlet portion.

A diameter at a joint portion of the protrusion-starting portion and the protrusion-keeping portion may be larger than a diameter in a joint portion of the protrusion-keeping portion and the protrusion-ending portion.

When a diameter of the inlet portion may be D, a diameter of the outlet portion may be d, a distance between the inlet portion and the outlet portion may be L, a length of the protrusion-keeping portion may be L1, a length of the tumble generating protrusion which may be measured along the wall may be L2, an angle between the protrusion-starting portion and the protrusion-keeping portion may be a1, an angle between the protrusion-ending portion and the protrusion-keeping portion may be a2, and a maximum distance from the wall to the protrusion-keeping portion may be h, the injector hole structure satisfies relationships of −(D+d)/2<h<(D+d)/2, wherein approximately 90 degrees≦a1<approximately 180 degrees, approximately 90 degrees≦a2<approximately 180 degrees, L1≦L2, and L2<L.

In another aspect of the present invention, a plurality of the tumble generating protrusions may be formed between the inlet portion and the outlet portion.

The wall and the protrusion-starting portion, the protrusion-starting portion and the protrusion-keeping portion, the protrusion-keeping portion and the protrusion-ending portion, and the protrusion-ending portion and the wall may be respectively connected at a predetermined angle.

At least one or more of joint portions between the wall and the protrusion-starting portion, the protrusion-starting portion and the protrusion-keeping portion, the protrusion-keeping portion and the protrusion-ending portion, and the protrusion-ending portion and the wall may be rounded, and the others may be angularly connected.

In further another aspect of the present invention, an injector hole structure for an engine may include an inlet portion and an outlet portion, a wall narrowing from the inlet portion to the outlet portion, and a tumble generating groove depressed on an inner surface of the wall away from a center axis of the wall and having a concentric circular shape with the inlet portion or the outlet portion.

The inlet portion and the outlet portion may be coaxially arranged, wherein the tumble generating groove involves a groove-starting portion, a groove-keeping portion, and a groove-ending portion, which may be sequentially connected along the inner surface of the wall in a direction from the inlet portion toward the outlet portion.

A diameter at a joint portion of the groove-starting portion and the groove-keeping portion may be larger than a diameter in a joint portion of the groove-keeping portion and the groove-ending portion.

When a diameter of the inlet portion may be D, a diameter of the outlet portion may be d, a distance between the inlet portion and the outlet portion may be L, a length of the groove-keeping portion may be RL1, a length of the tumble generating groove which may be measured along the wall may be RL2, an angle between the groove-starting portion and the groove-ending portion may be Ra1, an angle between the groove-ending portion and the groove-keeping portion may be Ra2, and a maximum distance from the wall to the groove-keeping portion may be Rh, the injector hole structure satisfies relationships of −(D+d)/2<Rh<(D+d)/2, wherein approximately 90 degrees≦Ra1<approximately 180 degrees, approximately 90 degrees≦Ra2<approximately 180 degrees, RL1≦RL2, and RL2<L.

In further another aspect of the present invention, a plurality of the tumble generating grooves may be formed between the inlet portion and the outlet portion.

The wall and the groove-starting portion, the groove-starting portion and the groove-keeping portion, the groove-keeping portion and the groove-ending portion, and the groove-ending portion and the wall may be respectively connected at a predetermined angle.

At least one or more of joint portions between the wall and the groove-starting portion, the groove-starting portion and the groove-keeping portion, the groove-keeping portion and the groove-ending portion, and the groove-ending portion and the wall may be rounded, and the others may be angularly connected.

According to the exemplary embodiments of the present invention, it is possible to ensure high output of the engine to be advantageous in fuel efficiency and reduce toxic substances in the exhaust gas, by forming a tumble generating protrusion or a tumble generating groove in the injector hole such that sufficient mixing efficiency of fuel and air is ensured by inducing tumble in the combustion chamber and a sufficient amount of fuel is injected.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing an injector hole structure for an engine according to an exemplary embodiment of the present invention.

FIG. 2 is a graph comparing effects of the injector holes according to an exemplary embodiment of the present invention and the related art.

FIGS. 3 to 5 are views showing another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

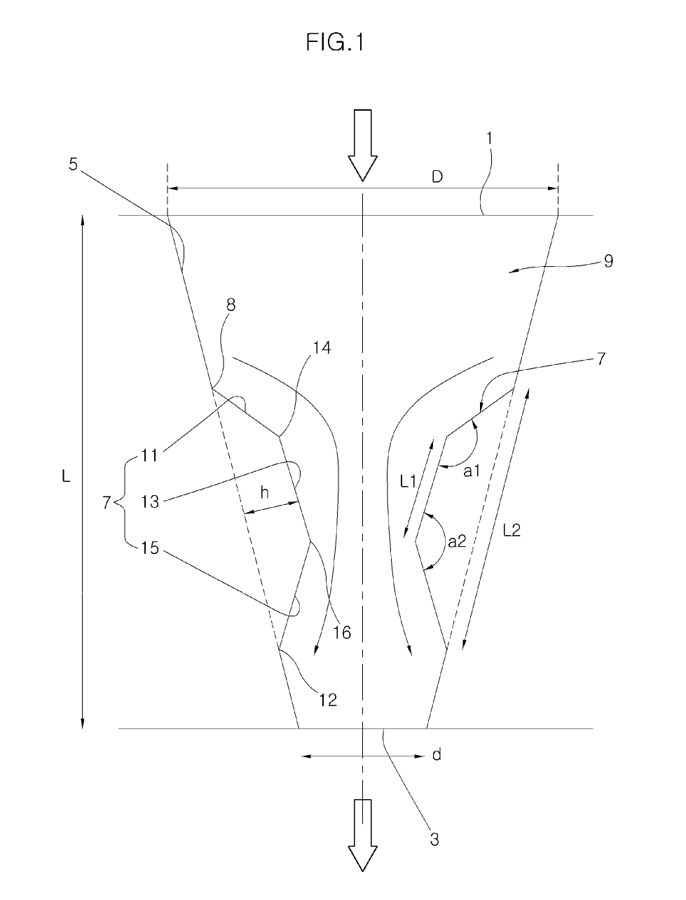

Referring to FIG. 1, an injector hole according to an exemplary embodiment of the present invention has a wall 5 narrowing straight from an inlet portion 1 to an outlet portion 3 and a tumble generating protrusion 7 protruding from wall 5 and making a circle parallel with inlet portion 1.

That is, one or more injector holes 9 having the structure described above are formed in an injector that is mounted in a combustion chamber, such that as the injector injects fuel, a sufficient amount of fuel generates tumble in the combustion chamber.

Inlet portion 1 and outlet portion 3 are coaxially arranged and tumble generating protrusion 7 includes a protrusion-starting portion 11, a protrusion-keeping portion 13, and a protrusion-ending portion 15, which are sequentially connected, from inlet portion 1.

When the diameter of inlet portion 1 is D, the diameter of outlet portion 3 is d, the distance between inlet portion 1 and outlet portion 3 is L, the length of protrusion-keeping portion 13 is L1, the length of tumble generating protrusion 7 which is measured along wall 5 is L2, the angle between protrusion-starting portion 11 and protrusion-keeping portion 13 is a1, the angle between protrusion-ending portion 15 and protrusion-keeping portion 13 is a2, and the maximum distance from wall 5 to protrusion-keeping portion 13 is h, the structure of injector hole 9 satisfies the following relationships.

−(D+d)/2<h<(D+d)/2,

90 degrees≦a1<180 degrees,

90 degrees≦a2<180 degrees,

L1≦L2,

L2<L

That is, since tumble generating protrusion 7 having the shape substantially similar to that shown in FIG. 1 protrudes, making one circular string in injector hole 9, a sufficient amount of fuel is injected and the flow is influenced through injector hole 9 by tumble generating protrusion 7, such that the fuel is mixed with air, more smoothly generating tumble in the combustion chamber.

In an exemplary embodiment of the present invention, a diameter at a joint portion 14 of the protrusion-starting portion 11 and the protrusion-keeping portion 13 may be larger than a diameter in a joint portion of the protrusion-keeping portion 13, and the protrusion-ending portion 15.

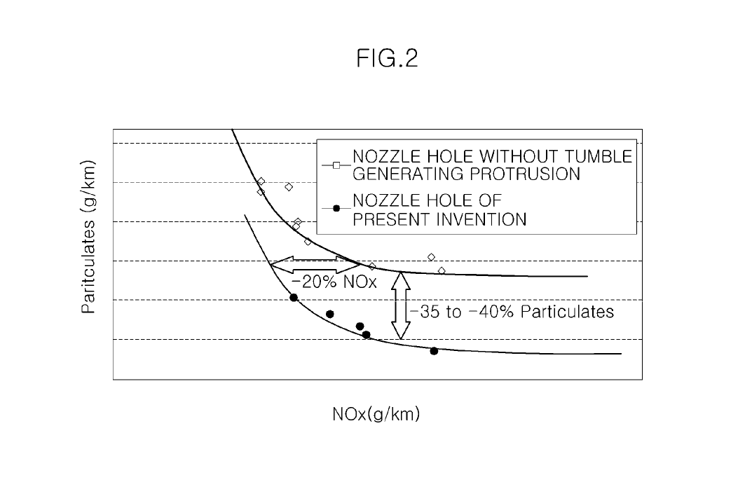

FIG. 2 is a graph showing the experimental result of comparing nitrogen oxide NOx and particulates that are toxic substances in the exhaust gas generated from the engine in which fuel is injected by the injector having injector holes 9 formed as described above with those from an engine in which fuel is injected by an injector having the same-sized injector holes 9 without tumble generating protrusion 7, in which it can be seen that the nitrogen oxide reduced by about 20% and the particulates reduced by about 35 to 40%.

In the exemplary embodiment, wall 5 and protrusion-starting portion 11, protrusion-starting portion 11 and protrusion-keeping portion 13, protrusion-keeping portion 13 and protrusion-ending portion 15, and protrusion-ending portion 15 and wall 15 are respectively connected at a predetermined angle, while at least one or more of the joint portions 8, 14, 16, and 12 between wall 5 and protrusion-starting portion 11, protrusion-starting portion 11 and protrusion-keeping portion 13, protrusion-keeping portion 13 and protrusion-ending portion 15, and protrusion-ending portion 15 and wall 5 may be rounded and the others may be angularly formed, or all of the joint portions 8, 14, 16, and 12 may be rounded.

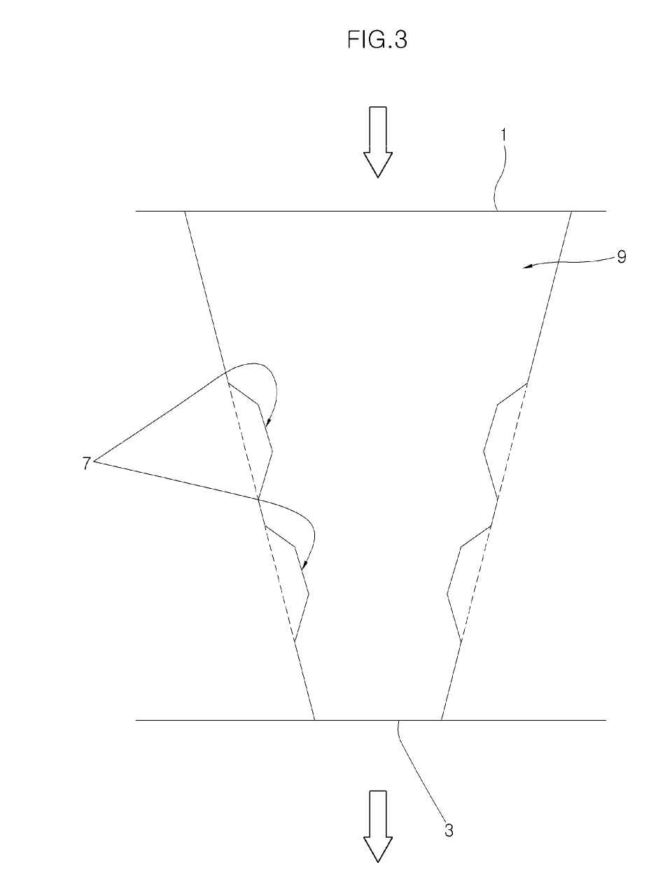

FIG. 3 shows another exemplary embodiment of the present invention, in which a plurality of tumble generating protrusions 7 is formed between inlet portion 1 and outlet portion 3. That is, two tumble generating protrusions 7 are formed, but more number of tumble generating protrusions may be formed.

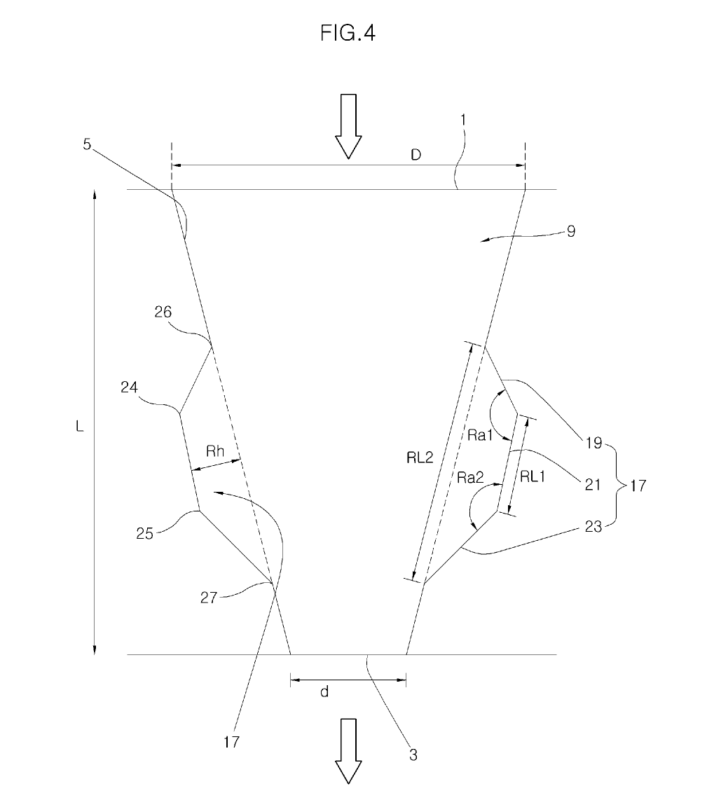

Further, FIG. 4 shows another exemplary embodiment of the present invention, in which tumble generating protrusion 7 is replaced by a tumble generating groove 17.

That is, in the exemplary embodiment shown in FIG. 4, an injector hole has a wall 5 narrowing straight from an inlet portion 1 to an outlet portion 3 and a tumble generating groove 17 depressed on wall 5 and making a concentric circular shape with inlet portion 1.

Inlet portion 1 and outlet portion 3 are coaxially arranged and tumble generating groove 17 includes a groove-starting portion 19, a groove-keeping portion 21, and a groove-ending portion 23, which are sequentially connected, from inlet portion 1.

When the diameter of inlet portion 1 is D, the diameter of outlet portion 3 is d, the distance between inlet portion 1 and outlet portion 3 is L, the length of groove-keeping portion 21 is RL1, the length of tumble generating groove 17 which is measured along wall 5 is RL2, the angle between groove-starting portion 19 and groove-keeping portion 21 is Ra1, the angle between groove-ending portion 23 and groove-keeping portion 21 is Ra2, and the maximum distance from wall 5 to groove-keeping portion 21 is Rh, the structure of injector hole 9 satisfies the following relationships.

−(D+d)/2<Rh<(D+d)/2,

90 degrees≦Ra1<180 degrees,

90 degrees≦Ra2<180 degrees,

RL1<RL2,

RL2<L

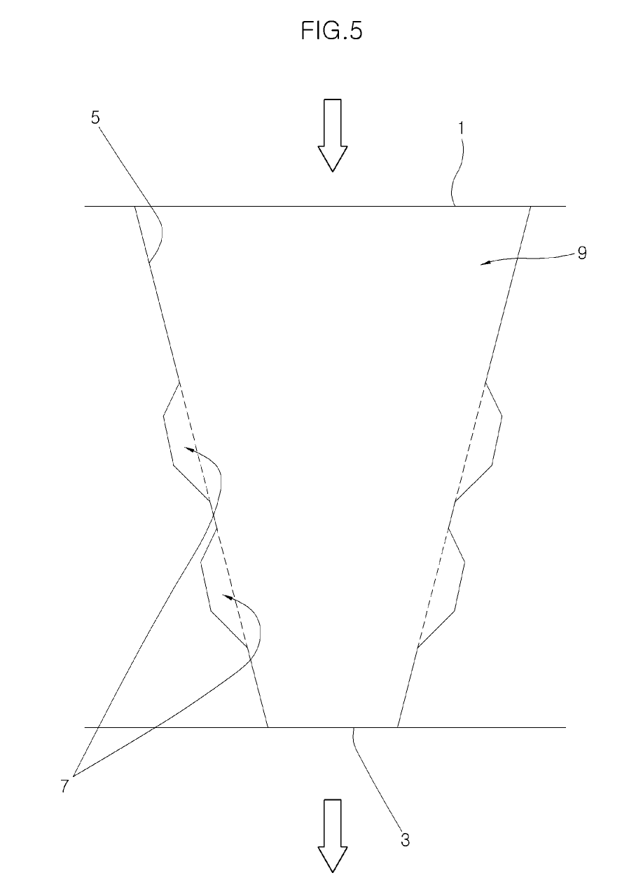

Obviously, only one tumble generating groove 17 may be formed between inlet portion 1 and outlet portion 3, as shown in FIG. 4, or a plurality of tumble generating grooves may be formed, as shown in FIG. 5.

In an exemplary embodiment of the present invention, a diameter at a joint portion 24 of the groove-starting portion 19 and the groove-keeping portion 21 is larger than a diameter in a joint portion 25 of the groove-keeping portion 21, and the groove-ending portion 23.

Further, in the exemplary embodiment, wall 5 and groove-starting portion 19, groove-starting portion 19 and groove-keeping portion 21, groove-keeping portion 21 and groove-ending portion 23, and groove-ending portion 23 and wall 5 are respectively connected at a predetermined angle, while at least one or more of the joint portions 26, 24, 25, and 27 between wall 5 and groove-starting portion 19, groove-starting portion 19 and groove-keeping portion 21, groove-keeping portion 21 and groove-ending portion 23, and groove-ending portion 23 and wall 5 may be rounded and the others may be angularly formed, or all of the joint portions 26, 24, 25, and 27 may be rounded.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An injector hole structure for an engine, comprising:
an inlet portion and an outlet portion;
a wall narrowing from the inlet portion to the outlet portion; and
a tumble generating protrusion protruding from an inner surface of the wall toward a center axis of the wall and having a concentric circular shape with the inlet portion or the outlet portion.

2. The injector hole structure for the engine as defined in claim 1,
wherein the inlet portion and the outlet portion are coaxially arranged; and
wherein the tumble generating protrusion includes a protrusion-starting portion, a protrusion-keeping portion, and a protrusion-ending portion, which are sequentially connected along the inner surface of the wall in a direction from the inlet portion toward the outlet portion.

3. The injector hole structure for the engine as defined in claim 2, wherein a diameter at a joint portion of the protrusion-starting portion and the protrusion-keeping portion is larger than a diameter in a joint portion of the protrusion-keeping portion and the protrusion-ending portion.

4. The injector hole structure for the engine as defined in claim 2, wherein when a diameter of the inlet portion is D, a diameter of the outlet portion is d, a distance between the inlet portion and the outlet portion is L, a length of the protrusion-keeping portion is L1, a length of the tumble generating protrusion which is measured along the wall is L2, an angle between the protrusion-starting portion and the protrusion-keeping portion is a1, an angle between the protrusion-ending portion and the protrusion-keeping portion is a2, and a maximum distance from the wall to the protrusion-keeping portion is h, the injector hole structure satisfies relationships of −(D+d)/2<h<(D+d)/2, wherein approximately 90 degrees≦a1<approximately 180 degrees, approximately 90 degrees≦a2<approximately 180 degrees, L1≦L2, and L2<L.

5. The injector hole structure for the engine as defined in claim 4, wherein a plurality of the tumble generating protrusions is formed between the inlet portion and the outlet portion.

6. The injector hole structure for the engine as defined in claim 5, wherein the wall and the protrusion-starting portion, the protrusion-starting portion and the protrusion-keeping portion, the protrusion-keeping portion and the protrusion-ending portion, and the protrusion-ending portion and the wall are respectively connected at a predetermined angle.

7. The injector hole structure for the engine as defined in claim 5, wherein at least one of joint portions between the wall and the protrusion-starting portion, the protrusion-starting portion and the protrusion-keeping portion, the protrusion-keeping portion and the protrusion-ending portion, and the protrusion-ending portion and the wall are rounded, and the others are angularly connected.

8. An injector hole structure for an engine, comprising:
an inlet portion and an outlet portion;
a wall narrowing from the inlet portion to the outlet portion; and
a tumble generating groove depressed on an inner surface of the wall away from a center axis of the wall and having a concentric circular shape with the inlet portion or the outlet portion.

9. The injector hole structure for the engine as defined in claim 8,
wherein the inlet portion and the outlet portion are coaxially arranged; and
wherein the tumble generating groove involves a groove-starting portion, a groove-keeping portion, and a groove-ending portion, which are sequentially connected along the inner surface of the wall in a direction from the inlet portion toward the outlet portion.

10. The injector hole structure for the engine as defined in claim 9, wherein a diameter at a joint portion of the groove-starting portion and the groove-keeping portion is larger than a diameter in a joint portion of the groove-keeping portion and the groove-ending portion.

11. The injector hole structure for the engine as defined in claim 9, wherein when a diameter of the inlet portion is D, a diameter of the outlet portion is d, a distance between the inlet portion and the outlet portion is L, a length of the groove-keeping portion is RL1, a length of the tumble generating groove which is measured along the wall is RL2, an angle between the groove-starting portion and the groove-ending portion is Ra1, an angle between the groove-ending portion and the groove-keeping portion is Ra2, and a maximum distance from the wall to the groove-keeping portion is Rh, the injector hole structure satisfies relationships of −(D+d)/2<Rh<(D+d)/2, wherein approximately 90 degrees≦Ra1<approximately 180 degrees, approximately 90 degrees≦Ra2<approximately 180 degrees, RL1≦RL2, and RL2<L.

12. The injector hole structure for the engine as defined in claim 9, wherein a plurality of the tumble generating grooves is formed between the inlet portion and the outlet portion.

13. The injector hole structure for the engine as defined in claim 12, wherein the wall and the groove-starting portion, the groove-starting portion and the groove-keeping portion, the groove-keeping portion and the groove-ending portion, and the groove-ending portion and the wall are respectively connected at a predetermined angle.

14. The injector hole structure for the engine as defined in claim 12, wherein at least one of joint portions between the wall and the groove-starting portion, the groove-starting portion and the groove-keeping portion, the groove-keeping portion and the groove-ending portion, and the groove-ending portion and the wall are rounded, and the others are angularly connected.
